(19) United States
(12) Patent Application Publication
(10) Pub. No.: US 2025/0267590 A1
(43) Pub. Date: Aug. 21, 2025

(54) Method And Apparatus For Enhanced Beam Configuration In Wireless Communications

(71) Applicant: MediaTek Inc., Hsinchu City (TW)

(72) Inventors: Gilles Charbit, Cambridge (GB); Abdelkader Medles, Cambridge (GB); Pradeep Jose, Cambridge (GB); Waseem Hazim Ozan Ozan, Cambridge (GB); Ogeen Hanna Toma Toma, Cambridge (GB)

(21) Appl. No.: 19/034,596

(22) Filed: Jan. 23, 2025

Related U.S. Application Data
(60) Provisional application No. 63/554,248, filed on Feb. 16, 2024.

(51) Int. Cl. H04W 52/34; H04W 52/42; H04W 84/06

(52) U.S. Cl. CPC H04W 52/346; H04W 52/42; H04W 84/06

(57) ABSTRACT

Various solutions for enhanced beam configuration in wireless communications are described. A network node may split a total transmission power into a first transmission power and a second transmission power. Then, the network node may configure one or more wide beams to share the first transmission power in serving one or more user equipments (UEs) within one or more first areas covered by the wide beams. Also, the network node may configure one or more narrow beams to share the second transmission power in serving one or more of the UEs within one or more second areas covered by the narrow beams.

### CROSS REFERENCE TO RELATED PATENT APPLICATION(S)

The present disclosure is part of a non-provisional application claiming the priority benefit of U.S. Patent Application No. 63/554,248, filed 16 Feb. 2024, the content of which herein being incorporated by reference in its entirety.

### TECHNICAL FIELD

The present disclosure is generally related to mobile communications and, more particularly, to enhanced beam configuration in wireless communications.

### BACKGROUND

Unless otherwise indicated herein, approaches described in this section are not prior art to the claims listed below and are not admitted as prior art by inclusion in this section.

In 3^{rd} generation partnership project (3GPP) Release 17, non-terrestrial network (NTN) is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) user equipment (UE). NR NTN uses the 5G NR framework to enable direct connection between satellites and smartphones to provide voice and data services.

Typically, the total satellite transmission power for downlink (DL) transmission on the service link is split equally between multiple beams that are simultaneously active. However, this will result in lower transmission power per active beam. FIG. 1 illustrates an example scenario 100 of satellite beam configuration under current NTN framework. As shown in FIG. 1, the satellite is configured with K_{active}=8 active beams, including 1 wide beam (or called coarse beam) and 7 narrow beams (or called fine beams). Assuming the total transmission power of the satellite as Sₜₒₜₐₗ, the transmission power available for each active beam would be Sₜₒₜₐₗ/N_{active}, resulting in a non-ideal SNR loss per beam of Loss=10*LOG 10 (K_{active})=9 decibel (dB).

Accordingly, how to enhance satellite beam configuration becomes an important issue for modern wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhanced beam configuration in wireless communications. It is believed that the above-described issue would be avoided or otherwise alleviated by implementing one or more of the proposed schemes described herein.

In one aspect, a method may involve a network node splitting a total transmission power into a first transmission power and a second transmission power. The method may also involve the network node configuring one or more wide beams to share the first transmission power in serving one or more user UEs within one or more first areas covered by the wide beams. The method may further involve the network node configuring one or more narrow beams to share the second transmission power in serving one or more of the UEs within one or more second areas covered by the narrow beams.

In one aspect, an apparatus operating as a network node may comprise a transceiver which, during operation, wirelessly communicates with at least one UE. The apparatus may also comprise a processor communicatively coupled to the transceiver. The processor, during operation, may perform operations comprising splitting a total transmission power into a first transmission power and a second transmission power. The processor may also perform operations comprising configuring one or more wide beams to share the first transmission power in serving, via the transceiver, one or more UEs within one or more first areas covered by the wide beams. The processor may further perform operations comprising configuring one or more narrow beams to share the second transmission power in serving, via the transceiver, one or more of the UEs within one or more second areas covered by the narrow beams.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of satellite beam configuration under current NTN framework.

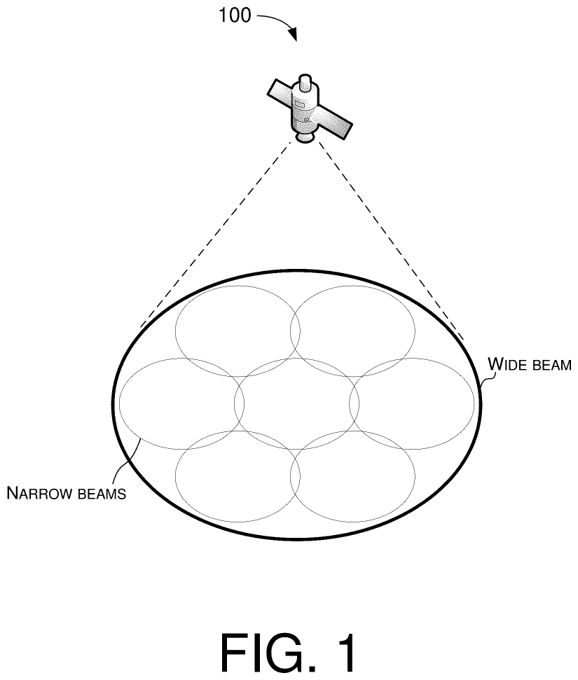

FIG. 2 is a diagram depicting an example scenario of a communication environment in which various solutions and schemes in accordance with the present disclosure may be implemented.

FIG. 3 is a diagram depicting an example scenario of satellite beam configurations in accordance with an implementation of the present disclosure.

FIG. 4 is a diagram depicting an example scenario of satellite transmission power splitting between a wide beam and multiple narrow beams in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced beam configuration in wireless communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

Under current NTN framework, with the assumptions of antenna loss being −5.5 dBi and polarization loss being 3 dB, the carrier-to-noise ratio (CNR) (also referred to as C/N) value for DL coverage enhancement (CovEnh) in the case of 600 km LEO with satellite parameter set 1 is −1.9 dB. Assuming N beams in total, the transmission power (e.g., effective/equivalent isotropic radiated power (EIRP)) per beam scales down by 10*LOG (N) dB (i.e., equally split between the active beams). Consequently, this results in lower transmission power per active beam.

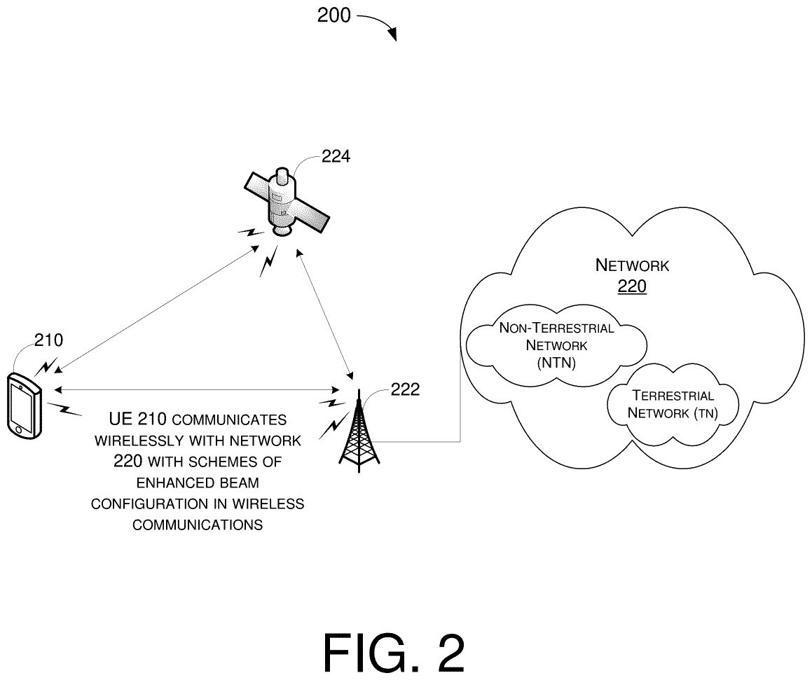

In view of the above, the present disclosure is motivated by, but not limited to, NTN scenarios, and accordingly proposes a number of schemes pertaining to enhanced beam configuration in wireless communications. FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including an NTN and a TN) via a terrestrial network node 222 (e.g., a base station (BS) such as an evolved Node-B (eNB), a Next Generation Node-B (gNB), or a transmission/reception point (TRP)) and/or a non-terrestrial network node 224 (e.g., a satellite). For example, the terrestrial network node 222 and/or the non-terrestrial network node 224 may form an NTN serving cell for wireless communication with the UE 210. In such communication environment, the UE 210, the network 220, the terrestrial network node 222, and the non-terrestrial network node 224 may implement various schemes pertaining to enhanced beam configuration in wireless communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

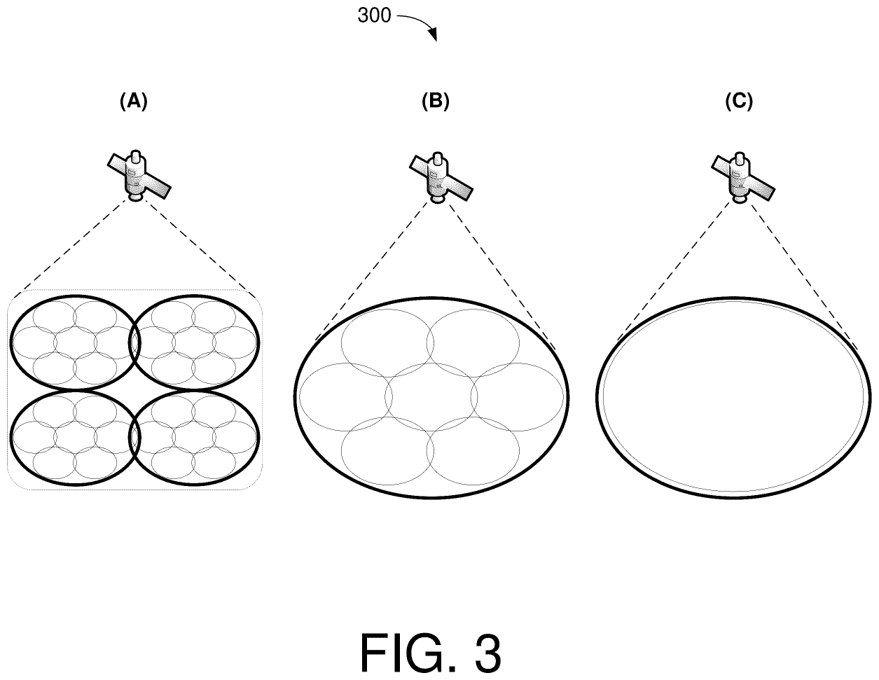

FIG. 3 illustrates an example scenario 300 of satellite beam configurations in accordance with an implementation of the present disclosure. Part (A) of FIG. 3 depicts a satellite forming a multiple-beam cell with 4 wide beams and 7 narrow beams within each wide beam. Part (B) of FIG. 3 depicts a satellite forming a multiple-beam cell with 1 wide beam and 7 narrow beams within the wide beam. Part (C) of FIG. 3 depicts a satellite forming a single-beam cell. In general, each wide beam and narrow beam covers a geographical area where one or more UEs may be located. For example, a wide beam may cover a relatively large area to serve UE(s) within that area for DL synchronization, system information (e.g., at least system information block type 1 (SIB1)) acquisition, and/or initial access. A narrow beam may cover a relatively small area to serve UE(s) within that area for data transmission.

Under the first proposed scheme in accordance with the present disclosure, the total satellite transmission power (or EIRP) may be flexibly split between wide beam(s) and narrow beam(s) with different C/N conditions to allow SNR gain for a given narrow beam. This allows different assumptions for C/N on wide beam and C/N on narrow beam. The wider beam(s) may be configured to be always ON (i.e., activated), while the narrow beams may be configured to be ON (i.e., activated) or OFF (i.e., deactivated) as required.

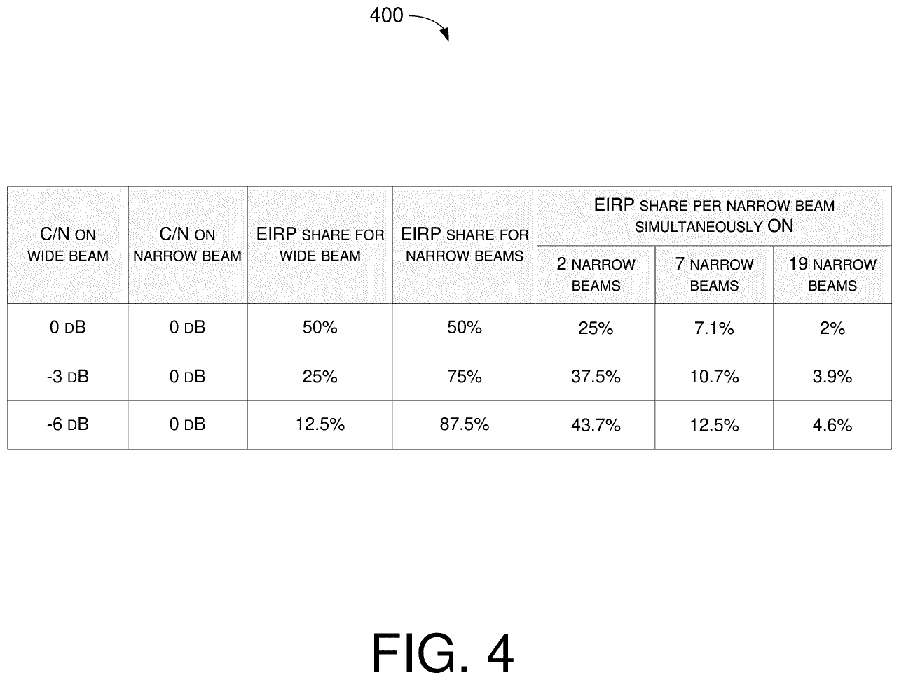

FIG. 4 illustrates an example scenario 400 of satellite transmission power splitting between a wide beam and multiple narrow beams in accordance with an implementation of the present disclosure. As shown in FIG. 4, the C/N on wide beam and the C/N on narrow beam may be (dynamically) adjusted to allow the total satellite transmission power to be split into one of multiple sets transmission power shares for the wide beam (i.e., the transmission power shared by the wide beam) and transmission power share for the narrow beams (i.e., the transmission power shared by the narrow beams). Specifically, in the case of the assumption that C/N on wide beam is 0 dB and C/N on narrow beam is 0 dB, the transmission power share for the wide beam is 50% of the total satellite transmission power and the transmission power share for the narrow beams is 50% of the total satellite transmission power. Next, based on the transmission power share for the narrow beams, the transmission power share per narrow beam may be determined by the number of simultaneously activated narrow beams. For example, the transmission power share per narrow beam is 25% of the total satellite transmission power, if there are 2 narrow beams simultaneously activated; the transmission power share per narrow beam is 7.1% of the total satellite transmission power, if there are 7 narrow beams simultaneously activated; and the transmission power share per narrow beam is 2% of the total satellite transmission power, if there are 19 narrow beams simultaneously activated. Likewise, the transmission power share for the wide beam and the transmission power share per narrow beam can be determined for the case of the assumption that C/N on wide beam is −3 dB and C/N on narrow beam is 0 dB, and the case of the assumption that C/N on wide beam is −6 dB and C/N on narrow beam is 0 dB.

Under the second proposed scheme in accordance with the present disclosure, a satellite (and/or BS) may increase the transmission power for a given narrow beam to reach a higher operating C/N target, such that the spectral efficiency of DL transmission may be increased to achieve higher throughput and capacity. With the wide beam reconfigured with relatively lower C/N, the transmission power gain for the active/activated narrow beams may be used to increase the C/N on narrow beam. For example, in the case of 7 narrow beams, up to 30.4% (=87.5%-50%-7.1%) additional power may be available for a given active/activated narrow beam, which corresponds to SNR gain of 6.31 dB (=10*log (30.4%/7.1%)). Additionally, or optionally, a satellite (and/or BS) may decrease the transmission power for narrow beam(s) to save the satellite's power consumption (and save satellite battery) when the satellite is in the dark (e.g., in the shadow of the Earth, Moon, or others) and solar panels cannot be used to power the satellite or charge the satellite battery. This mechanism of decreasing the transmission power for narrow beam(s) may be performed in addition to switching the narrow beams ON or OFF.

Under the third proposed scheme in accordance with the present disclosure, a satellite (and/or BS) may activate/deactivate partial or all narrow beams within a wide beam. In some implementations, the satellite (and/or BS) may switch ON/OFF all narrow beams within a wide beams. In some implementations, it is not necessary to activate all narrow beams within the wide beam. For example, the total satellite transmission power (e.g., EIRP) may be split between a wide beam that is always ON for initial access and activated narrow beam(s) that covers geographical area(s) where connected UE(s) (i.e., UE(s) operating in connected mode (e.g., RRC_CONNECTED mode)) is/are located. Additionally, or optionally, when the UE moves, the satellite (and/or BS) may start activating the neighboring narrow beam(s) based on UE's movements, as needed.

### Illustrative Implementations

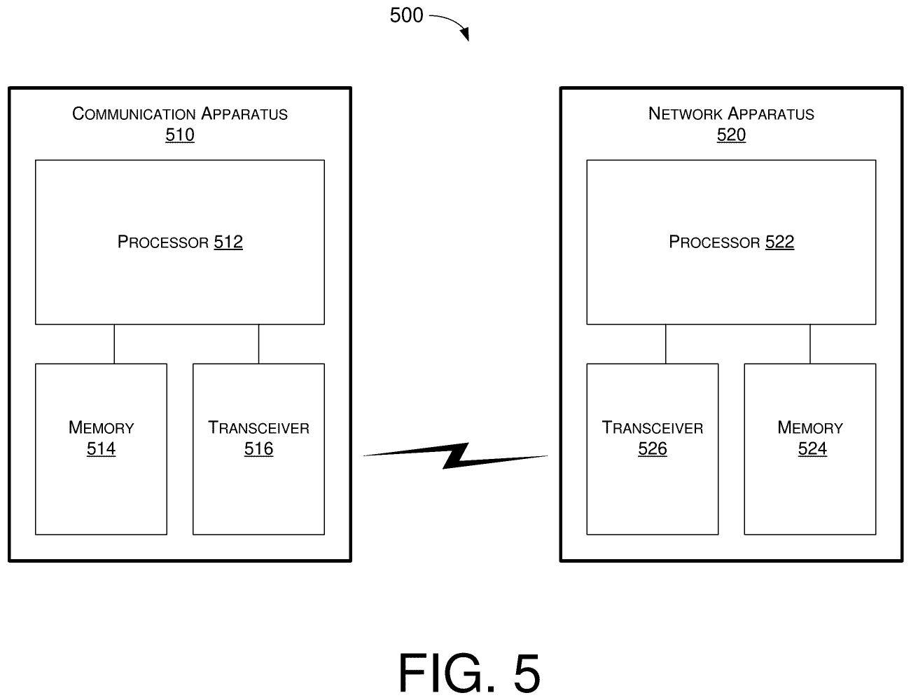

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to enhanced beam configuration in wireless communications, including scenarios/schemes described above as well as process 600 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a base station (BS), a small cell, a router or a gateway of an NTN. For instance, network apparatus 520 may be implemented in a satellite or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including enhanced beam configuration in wireless communications, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for beamforming and multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for beamforming and MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., a satellite or BS), is provided below with process 600.

### Illustrative Processes

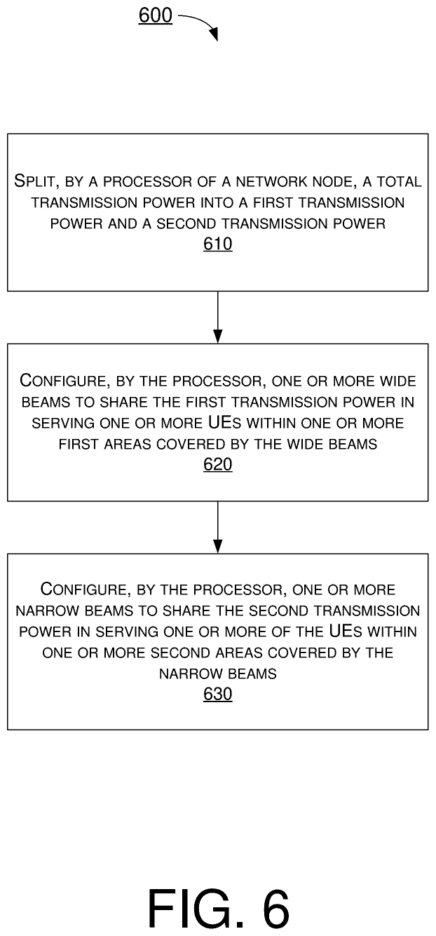

FIG. 6 illustrates an example process 600 in accordance with an implementation of the present disclosure. Process 600 may be an example implementation of above scenarios/schemes, whether partially or completely, with respect to enhanced beam configuration in wireless communications. Process 600 may represent an aspect of implementation of features of network apparatus 520. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in network apparatus 520 as well as any variations thereof. Solely for illustrative purposes and without limitation, process 600 is described below in the context of communication apparatus 510, as a UE, and network apparatus 520, as a network node. Process 600 may begin at block 610.

At 610, process 600 may involve processor 522 of network apparatus 520 splitting a total transmission power into a first transmission power and a second transmission power. Process 600 may proceed from block 610 to block 620.

At 620, process 600 may involve processor 522 configuring one or more wide beams to share the first transmission power in serving, via transceiver 516, one or more UEs within one or more first areas covered by the wide beams. Process 600 may proceed from block 620 to block 630.

At 630, process 600 may involve processor 522 configuring one or more narrow beams to share the second transmission power in serving one or more of the UEs within one or more second areas covered by the narrow beams.

In some implementations, the wide beams may be configured to serve the UEs within the first areas for DL synchronization, system information acquisition, or initial access.

In some implementations, the narrow beams may be configured to serve the UEs within the second areas for data transmission.

In some implementations, the wide beams and the narrow beams may be configured under different carrier-to-noise ratio (CNR) assumptions.

In some implementations, the wide beams may be configured to be always activated, and each of the narrow beams may be configurable to be activated or deactivated.

In some implementations, process 600 may further involve processor 522 decreasing the first transmission power to provide a power gain for the narrow beams.

In some implementations, process 600 may further involve processor 522 decreasing the second transmission power in an event that a satellite associated with the total transmission power is in a shadow.

In some implementations, the total transmission power may be split between the wide beams and one or more of the narrow beams that cover one or more areas where one or more UEs operating in a connected mode are located.

In some implementations, each of the second areas may be smaller than each of the first areas, and the second areas may be within the first areas.

In some implementations, the network node may include a satellite.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
splitting, by a processor of a network node, a total transmission power into a first transmission power and a second transmission power;
configuring, by the processor, one or more wide beams to share the first transmission power in serving one or more user equipments (UEs) within one or more first areas covered by the wide beams; and
configuring, by the processor, one or more narrow beams to share the second transmission power in serving one or more of the UEs within one or more second areas covered by the narrow beams.

2. The method of claim 1, wherein the wide beams are configured to serve the UEs within the first areas for downlink (DL) synchronization, system information acquisition, or initial access.

3. The method of claim 1, wherein the narrow beams are configured to serve the UEs within the second areas for data transmission.

4. The method of claim 1, wherein the wide beams and the narrow beams are configured under different carrier-to-noise ratio (CNR) assumptions.

5. The method of claim 1, wherein the wide beams are configured to be always activated, and each of the narrow beams is configurable to be activated or deactivated.

6. The method of claim 1, further comprising:
decreasing, by the processor, the first transmission power to provide a power gain for the narrow beams.

7. The method of claim 1, further comprising:
decreasing, by the processor, the second transmission power in an event that a satellite associated with the total transmission power is in a shadow.

8. The method of claim 1, wherein the total transmission power is split between the wide beams and one or more of the narrow beams that cover one or more areas where one or more UEs operating in a connected mode are located.

9. The method of claim 1, wherein each of the second areas is smaller than each of the first areas, and the second areas are within the first areas.

10. The method of claim 1, wherein the network node comprises a satellite.

11. An apparatus, operating as a network node, comprising:
a transceiver which, during operation, wirelessly communicates with at least one user equipment (UE); and
a processor communicatively coupled to the transceiver such that, during operation, the processor performs operations comprising:
splitting a total transmission power into a first transmission power and a second transmission power;
configuring one or more wide beams to share the first transmission power in serving, via the transceiver, one or more UEs within one or more first areas covered by the wide beams; and
configuring one or more narrow beams to share the second transmission power in serving, via the transceiver, one or more of the UEs within one or more second areas covered by the narrow beams.

12. The apparatus of claim 11, wherein the wide beams are configured to serve the UEs within the first areas for downlink (DL) synchronization, system information acquisition, or initial access.

13. The apparatus of claim 11, wherein the narrow beams are configured to serve the UEs within the second areas for data transmission.

14. The apparatus of claim 11, wherein the wide beams and the narrow beams are configured under different carrier-to-noise ratio (CNR) assumptions.

15. The apparatus of claim 11, wherein the wide beams are configured to be always activated, and each of the narrow beams is configurable to be activated or deactivated.

16. The apparatus of claim 11, wherein, during operation, the processor further performs operations comprising:
decreasing the first transmission power to provide a power gain for the narrow beams.

17. The apparatus of claim 11, wherein, during operation, the processor further performs operations comprising:
decreasing the second transmission power in an event that a satellite associated with the total transmission power is in a shadow.

18. The apparatus of claim 11, wherein the total transmission power is split between the wide beams and one or more of the narrow beams that cover one or more areas where one or more UEs operating in a connected mode are located.

19. The apparatus of claim 11, wherein each of the second areas is smaller than each of the first areas, and the second areas are within the first areas.

20. The apparatus of claim 11, wherein the apparatus is a network node comprising a satellite.
